(19) United States
(12) Patent Application Publication
(10) Pub. No.: US 2004/0134855 A1
(43) Pub. Date: Jul. 15, 2004

(54) Separation and quantification of vegetable oil components

(75) Inventors: Ronald T. Sleeter, Decatur, IL (US); Mark A. Whitehead, Decatur, IL (US)

Correspondence Address: STERNE, KESSLER, GOLDSTEIN & FOX PLLC, 1100 NEW YORK AVENUE, N.W., WASHINGTON, DC, 20005, US

(73) Assignee: Archer-Daniels-Midland Company

(21) Appl. No.: 10/623,706

(22) Filed: Jul. 22, 2003

Related U.S. Application Data
(60) Provisional application No. 60/397,107, filed on Jul. 22, 2002.

(51) Int. Cl. B01D 15/08

(52) U.S. Cl. 210/635; 210/656; 436/161

(57) ABSTRACT

A process for separation of components of vegetable oils is disclosed. The process utilizes a silica column of a particular size that allows for sufficient sample size and separation to provide good reproducibility, and also provides for quantitation of the polar and non-polar components of the oils. Samples are eluted from the silica column using a petroleum ether:diethyl ether solution of approximately 87:13.

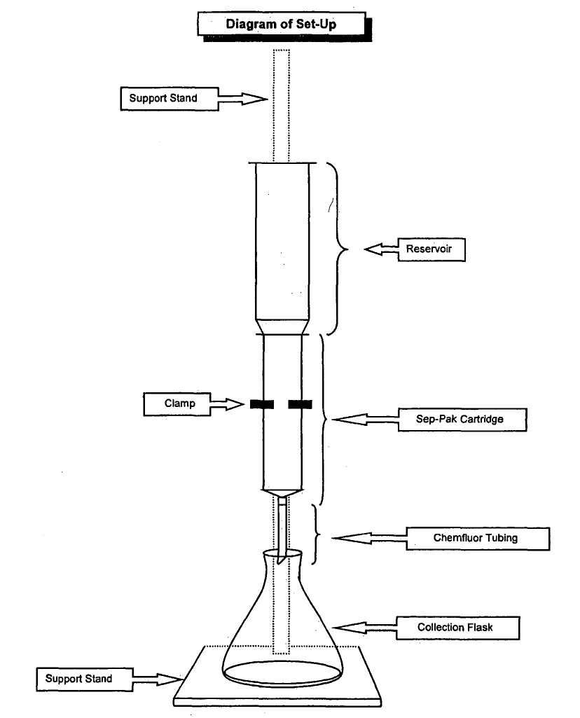

### CROSS-REFERENCE TO RELATED APPLICATIONS

This application claims the benefit of U.S. Provisional Application No. 60/397,107, filed Jul. 22, 2002, the entire contents of which are hereby incorporated by reference.

### BACKGROUND OF THE INVENTION

1. Field of the Invention

The present invention relates to a method for separating vegetable oil components. More particularly, the present invention relates to a gravity-flow elution method to separate polar and non-polar compounds of vegetable oils using disposable, prepacked silica separation columns such as the 5 gram silica Sep-Pak® columns.

2. Related Art

Polar compounds in vegetable oil include monoglycerides, diglycerides, free fatty acids, and polar transformation products that are formed as a result of heating. Non-polar compounds in vegetable oils are mainly unaltered triglycerides. Good reproducibility of polar compound separations and analytical results may be difficult to achieve when using either traditional glass-column liquid chromatography or smaller-size silica Sep-Pak® columns (see U.S. Pat. Nos. 4,211,658 and 4,250,035).

Various methods have been used to analyze the amount of polar compounds in vegetable oils, including glass-column liquid chromatography, high-pressure liquid chromatography (HPLC) and disposable silica Sep-Pak® columns. However, each method has inherent disadvantages. The traditional glass-column method of liquid chromatography is time-consuming and requires a large amount of solvent (“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)). HPLC can be used to analyze polar components, but the equipment is expensive and requires an experienced operator (Hamilton, J. G. and Comai, K., Lipids 23:1146-1149 (1988)). Previous work to separate polar components in vegetable oil using small (690 mg) silica Sep-Pak® cartridges has been done, but the method is sensitive to sample overloading and weighing errors due to the small amount of sample used (80-90 mg). Furthermore, the 690 mg cartridges do not facilitate gravity-flow elution (Sebedio,. J. L., et al., J Am. Oil Chem. Soc. 63:1541-1543 (1986)).

### SUMMARY OF THE INVENTION

To overcome problems encountered with the smaller 690 mg silica Sep-Pak® column, a larger (at least 5 gram) pre-packed silica separation column, such as the 5 gram Sep-Pak(t column (Waters, Milford, Mass.) can be used. Such a column allows a larger sample unit (200 mg) to be used without the effects of overloading. In addition, weighing errors are decreased because a larger sample mass can be used. The increased column length of the 5 gram Sep-Pak® column increases separation of zones and the increased diameter of the larger column allows an increase in sample capacity (Johnson, E. L. and Stevenson, R., Basic Liquid Chromatography, Varian, Palo Alto, Calif. (1978), p. 42). Gravity-flow elution is much easier with the 5 gram Sep-Pak® column due to the wider opening. The wider opening allows a more even distribution of ambient air pressure on the cartridge resulting in a smoother, more consistent gravity-elution flow rate than with the smaller 690 mg Sep-Pak® column. Using a larger silica Sep-Pak® column than previous work allows more sample to be loaded onto the column without overloading, facilitates gravity-flow elution, and minimizes weighing errors.

Therefore, the present invention relates to a process for the separation and analysis of components of vegetable oil. The process involves preparation of an oil sample for separation. An aliquot of the prepared sample is introduced into a pre-packed silica separation column, preferably the Sep-Pak® Vac cartridge 5 gram silica column. A larger, 10 gram Sep-Pak® Vac cartridge silica could be used, but method efficiencies and economics are reduced. For example, solvent usage and elution times would be increased significantly with the 10 gram column. The non-polar components of the oil are then eluted from the column with a solution of petroleum ether and diethyl ether having a petroleum ether:diethyl ether solvent ratio from about 92:8 to about 82:18, preferably from about 91:9 to about 83:17, more preferably from about 90:10 to about 84:16, more preferably from about 89:11 to about 85:15, more preferably from about 88:12 to about 86:14, more preferably of about 87:13. In a preferred embodiment the eluant is dried to remove the solvent, and the polar composition of the oil can be quantified by subtracting the mass of the dried non-polar component from the mass of the starting sample aliquot.

The various objects and advantages of the present invention will be clear from the description that follows.

### BRIEF DESCRIPTION OF THE FIGURES

The foregoing and other features and advantages of the invention will be apparent from the following, more particular description of a preferred embodiment of the invention, as illustrated in the FIGURE which shows a diagram of the set-up according to the process of the present invention.

### DETAILED DESCRIPTION OF THE INVENTION

In the present invention, a disposable Sep-Pak® Vac 20 cc (5 gram) silica cartridge is used as the column and a petroleum ether:diethyl ether solution is used as the solvent system. Extensive trials using the larger Sep-Pak® columns showed excellent reproducibility (Relative Standard Deviation (RSD) under 5.0%) and actual polar results compared favorably to glass-column trials. This method improved upon the glass-column chromatography technique of polar analysis of oils by using a quicker, simpler elution process, utilizing disposable pre-packed columns, reducing the amount of elution solvent needed, and most importantly, increasing the reproducibility of polar compound results.

The present invention provides a gravity-flow elution system to separate polar compounds in vegetable oils using a 5 gram silica Sep-Pak® column and a solvent system of 87:13 petroleum ether:diethyl ether. Only 30 mL of dilution solvent was used to elute each sample compared to 150 mL required in the glass column method (“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)). The amount of polar compounds was calculated in the same manner as in the traditional glass column chromatography method (“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)). Extensive trials of vegetable oil samples showed excellent reproducibility with a relative standard deviation of less than 5.0%. A sample could be easily and completely processed within an hour after elution was started (this includes elution time and solvent evaporation time). Because of upscaling the 690 mg Sep-Pak® to a 5 gram Sep-Pak®, an oil sample can be quickly and efficiently assessed for polar compounds with a high degree of reproducibility.

### EXAMPLE 1

Example 1 sets forth a specific embodiment of the present invention.

Materials and Methods

Materials

The petroleum ether and diethyl ether for the 87:13 (vol/vol) petroleum ether:diethyl ether elution solvent were purchased from Aldrich (Milwaukee, Wis.). The columns used were pre-packed Sep-Pak® Vac 20 cc 5 gram silica cartridges available from Waters Associates (Milford, Mass.), Chemfluor® fluoropolymer PTFE tubing (internal diameter=3.2 mm, outer diameter=6.4 mm, wall thickness=1.6 mm) was purchased from Norton (Wayne, N.J.) and used as an extension for the Luer end of the Sep-Pak® column. Pyrex glass enlarging adapters with standard tapers of 29/42 (outer joint) and 24/40 (inner joint) were purchased from Corning (Corning, N.Y.) and used as solvent reservoirs for the Sep-Pak® columns.

The ratio of petroleum ether:diethyl ether can vary from about 92:8 to about 82:18, preferably from about 91:9 to about 83:17, more preferably from about 90:10 to about 84:16, more preferably from about 89:11 to about 85:15, more preferably from about 88:12 to about 86:14, with corresponding change in chromatographic conditions.

Preliminary Preparation

The 25 mL Erlenmeyer sample-collection flasks were dried by desiccation for at least 2 hours in a 101° drying oven and allowed to cool to room temperature in a dessicator. A 4.4 cm piece of Chemfluor® tubing was cut at a 45° angle and the straight end force-fitted onto the Luer end of the Sep-Pak®. This extension allowed elution to take place inside the Erlenmeyer flask and minimized moisture condensation on the tubing during elution.

The Chemfluor® tubing was also resistant to plasticizer elution from the solvent. A 5 gram silica Sep-Pak® column was clamped to a ring stand with a 3-prong clamp so that the tip of the Chemfluor® tubing extended down about 1 cm inside the flask mouth.

Sample Preparation and Analysis

The oil sample was microwaved for one minute on high, thoroughly mixed by gentle swirling and inversion, and allowed to cool to room temperature. Four grams of oil were then added to a 100 mL wide-mouth volumetric flask and diluted to mark with petroleum ether. The solution was capped and mixed by gentle inversion and swirling. Weighing was done on an analytical balance accurate to 0.00001 g. A 5 mL aliquot of the sample solution (containing 0.20000±0.001 g of oil) was pipetted via a 5 mL Class A volumetric pipet onto the head of the Sep-Pak® column. Any sample residue remaining on the inner walls of the Sep-Pak® column was rinsed into the column with petroleum ether. The inner joint of the glass enlarging adapter is fitted firmly inside the top of the Sep-Pak® column and 30 ml of the 87:13 petroleum ether:diethyl ether elution solvent was added to the reservoir. After the non-polar components were eluted (˜20 minutes), the collection flask was dried on a hot plate at a low setting under a gentle stream of nitrogen until the solvent is visibly dried off (˜6 minutes). After the solvent is visibly dried off, the heating is continued for 5 minutes under nitrogen to ensue complete drying. The sample is then allowed to cool to room temperature under a stream of nitrogen (˜10 minutes). The heat must be low enough so that the sample does not boil over during drying and cause a loss of non-polar residue. The percentage of polar components (polar %, (w/w)), of the sample was determined by subtracting the weight of the non-polar residue (B) from the original sample mass (0.20000 g) in a 5.0 mL aliquot of sample solution (A):

$$\frac{A - B}{A} \times 100 \% = polar \% , ( w \text{/} w )$$

The linear working range for sample weight was tested from 150 mg to 250 mg in 20-30 mg increments. This analysis was found to be linear throughout the range tested and the 0.20000±0.001 g sample mass was optimal for the 5 g Sep-Pak® column.

Results and Discussion

In initial work, two processed cottonseed oils were used as samples, each having a low, but different amount of polar components. Each sample was analyzed using the traditional glass column technique to establish a reference baseline of polar % results. The same two samples were analyzed using the 5 gram silica Sep-Pak® method described above. The results are listed in Table 1.

TABLE 1
Comparison of Polar % (w/w) of Cottonseed Oil Samples
Using the Standard Glass Column Method and 5.0 gram
silica Sep-Pak ® Cartridges

| | Standard | | | | 5.0 gram | | | |
|---|---|---|---|---|---|---|---|---|
| | Glass Column Method | | | | silica Sep-Pak ® Method | | | |
| | | | | RSD | | | | RSD |
| Sample | n | Polar %^{a} | SD | (%)^{b} | N | Polar %^{a} | SD | (%)^{b} |
| A | 12 | 5.6 | 6.35 | 6.3 | 17 | 6.5 | 0.28 | 4.3 |
| B | 12 | 6.6 | 0.33 | 5.1 | 12 | 7.8 | 0.29 | 3.7 |

^{a}Polar % = (amount of sample − nonpolar components)/amount of sample × 100%.
^{b}RSD = SD/Avg. × 100%

For both cottonseed oil samples A and B, the variation of polar results was greater with samples analyzed with the glass column method than with the Sep-Pak® columns, exemplified by the greater RSD values for the glass column technique (Table 1). Some of this difference could be attributable to the consistency of the prepacked Sep-Pak® cartridges. With the glass column method, the silica adsorbent must be precisely hydrated to 5.0% (w/w) (“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)). If the hydration changes any before elution or any error occurs during the hydrating process, the polar % amount could be adversely affected. However, with the prepacked Sep-Pak® columns, the hydration step was eliminated as a potential error source.

The amount of polar components determined by the glass column method compared favorably to the Sep-Pak® method. For both samples A and B, the polar % results were slightly higher when using the Sep-Pak® columns (Table 1). The work of Sebedio, et al. showed that the polar % results were slightly lower when using the Sep-Pak® columns compared to the glass columns (Sebedio,. J. L., et al., J Am. Oil Chem. Soc. 63:1543 (1986)). The higher polar % for the Sep-Pak® columns in this analysis could be attributable to a gradual oxidizing of the oil samples over time since this analysis used the same samples over a period of about 2 months. Experience showed that microwaving the oil sample then mixing by gentle swirling and inversion prior to sample preparation minimized the effect of the polar % increasing over time. Precipitating fat crystals may have caused the increased polar % results and the heating and mixing could have melted the crystals, thereby keeping the polar % to a more consistent % value. It was also observed that as the sample solution sat for a few hours, the amount of sample mass in a 5 mL aliquot increased. Originally, the increase in the sample mass was thought to be from the loss of solvent due to evaporation but did not seem likely because the sample solution was tightly capped. A more plausible explanation could be peroxide contamination of the diethyl ether. If peroxides were present in the diethyl ether due to exposure to air, polyunsaturated fats could react with the peroxides and be oxidized into various polar products. For best results, the samples were eluted promptly, producing optimal results if used within two hours after preparation.

Much of the time expended during the research study for this analysis was spent trying to develop a gravity-flow system of elution for the Sep-Pak® columns. One attempt to simplify the process included a direct sample loading technique where the oil sample was weighed directly onto a tared Sep-Pak® column in order to eliminate the step of preparing a sample solution and to minimize weighing errors. Unfortunately, this method suffered from poor reproducibility, probably as a result of channeling as the elution solvent flowed around the unevenly-distributed oil in the column. The elution process was streamlined by using a reservoir for the elution solvent rather than using an addition funnel whose flow rate into the Sep-Pak® column was difficult to precisely control. When the elution reservoir was initially filled with 30 mL of elution solvent, the gravity-elution flow rate was ˜3 mL/min, and dropped off to ˜1 mL/min near the end of the elution. Trials were run which showed that this minor change in the flow rate during elution produced no significant change in the polar % results. This step freed the operator from having to continuously monitor the flow rate from the addition funnel in order to keep the elution solvent height above the Sep-Pak® column consistent. Multiple samples were run easily and quickly, with the limiting factor in the process being the capacity of the drying system for the collection flasks. Although not done in this study, the efficiency of the column may be determined by Thin Layer Chromatography of the polar and non-polar fractions by the same procedure used in the standard glass column method (“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)).

In subsequent work, other oils were analyzed as well. These oils included sunflower, soy, canola, corn, and coconut oils. Frying oils with polar % values ranging from 10-25% were also analyzed. Even more highly oxidized oils with polar % values in the range of 40-70% were examined as well. In addition, hydrogenated oils, including shortening, were analyzed. The relative standard of deviation for all of these oils were similar.

The reproducibility of the 5 gram silica Sep-Pak® column gravity-flow method was more consistent than the glass column method for separating polar components in vegetable oils, and the polar % results were comparable to the glass column method. In addition, the Sep-Pak® column method was quicker and more solvent efficient. This method could provide a quick, yet, easy way to improve reproducibility for the determination of polar compounds in oils.

### EXAMPLE 2

Example 2 outlines, in additional detail, an embodiment of the present invention. The polar component of fats and oils can be measured using a Sep-Pak® Vac 20 cc, (5 gram) silica cartridge. The polar and nonpolar components are separated on the silica gel in the Sep-Pak® cartridge. The elution solvent used is an 87:13 solution of petroleum ether:ethyl ether. The separation is achieved because the polar components have an affinity to the polar silica gel, while the nonpolar components elute through. Thus, the nonpolar components are eluted into a collection flask, while the polar components remain on the silica gel of the Sep-Pak® cartridge. After the collection flask is dried, the amount of polar components is calculated indirectly by subtracting the weight of the residue left in the collection flask from the weight of the original sample added to the Sep-Pak® cartridge.

First, the equipment necessary for carrying out the specific embodiment is listed, followed by preparation procedures and analysis procedures. Disposal, storage, control range establishment, and clean up procedures are also provided.

Equipment

| | |
|---|---|
| Volumetric Flask: | Pyrex Class “A”, 100 ml volumetric with bulbed neck |
| | [Corning 5820-100] and polyethylene stopper [Fisher |
| | 146441 C] |
| Volumetric Pipet: | Corex Class “A”, 5 ml [Corning 7100A-5] |
| Erlenmeyer Flask: | 25 ml, with 14/20 outer joint [Reliance R-4420-016 or |
| | equivalent] |
| Column. | Sep-Pak ® Vac 20 cc (5 gram) silica cartridge [Waters |
| | WAT036930] |
| Tubing: | Chemfluor ® Fluoropolymer PTFE Tubing (internal |
| | diameter = 3.2 mm, outside diameter = 6.4 mm, wall |
| | thickness = 1.6 mm) [Norton AXH0007] |
| Enlarging | Outer joint = 29/42, inner joint = 24/40 [Corning |
| Adapter: | 8800-2924] |
| Pasteur Pipets: | 5¾″ disposable borosilicate glass [Fisher 13-678- |
| | 20B] |
| Graduated | 50 ml, 500 ml |
| Cylinders: | |
| Hot Plate: | Combination hotplate/stirrer, Corning, Model PC-320 |
| | [Corning 6795-320] |
| Clamp, 2¼″ | Castaloy ® 2¼″ grip, 3-prong [Fisher 05-769-7] |
| grip: | |
| Clamp, 1″ grip: | Castaloy ® 1″ grip, 3-prong [Fisher 05-769-6] |
| Analytical | Accurate to 0.00001 gram [Mettler/Toledo AG 285 or |
| Balance: | Sartorius BP 211D] |
| Gloves | Nitrile [Fisher 18-999-4409] |
| Dessicator | |
| Funnel, glass, | [Fisher 10-346-5B] |
| 80 mm diam. | |
| Fume Hood: | Class A |
| Rectangular | |
| Support Stand | |
| Dry Nitrogen Gas | |
| Brown Glass | Cleaned thoroughly, then dried in oven at 102° C. |
| 1-lite Jug: | for at least 2 hours |
| Drying Oven | |
| Reagents | |
| Petroleum Ether: | Aldrich Spectrophotometric Grade [Aldrich 26, 173-4] |
| Ethyl Ether: | [Aldrich 17, 926-4] |
| Bottles, amber, | Qorpak 4 oz with polyvinyl closures [Fisher |
| glass | 03-326-5C] |
| Heat Gun | Heat-Blo Gun, 149°-260° C., 10 A [Fisher 09-201-10] |

Preparation

1) Always use gloves when handling all weighed glassware. Natural oils in skin can cause weighing errors.

2) Clean, then dry the 25 ml Erlenmeyer flasks in a drying oven at approximately 102° C. for at least 2 hours. These are to be used for collecting samples eluting through from the columns. It is most convenient to keep all clean Erlenmeyer flasks in oven until needed.

3) Remove the Erlenmeyer flasks from drying oven, label, and place in dessicator next to balance to equilibrate for at least 30 minutes. This allows samples to equilibrate to the same ambient temperature as the balance which minimizes drifting during weighing. At the same time, put the 100 ml volumetric flasks (minus stoppers) in the dessicator to equilibrate. Also at the same time, microwave the oil sample for 30-40 seconds to slightly warm the oil to dissolve any crystalline fractions. This is for sample bottles up to 250 mL; time may be longer if a larger sample size is used. The bottle should be just slightly warm to the touch. Gently swirl, and place the bottle near the balance to also equilibrate at least 30 minutes.

4) After 30 minutes equilibration, weigh the labeled Erlenmeyer flasks to the nearest 0.00001 gram. At the same time, weigh 4.0 grams of oil into a tared volumetric flask to the nearest 0.00001 gram using a disposable glass 5¼″ Pasteur pipet.

Solvent Preparation

1) While the samples are equilibrating in the steps above, add 435 ml of petroleum ether to a 500 ml graduated cylinder.

2) Add ethyl ether to the 500 ml mark (65 ml ethyl ether).

3) Pour contents of graduated cylinder into a dried brown glass 1-liter jug. Cap tightly and mix well by swirling contents.

The analysis of each sample requires 30 ml of solvent. Therefore, 500 ml of solvent is enough for approximately 15-16 samples.

Experience has shown that when the elution solvent gets too low in the jug, it may cause the % polar amounts to fluctuate. When the solvent gets low in the bottle, there is the possibility that the petroleum ether/ether composition may change due to the difference in partial pressures between the two solvent components. The potential change in composition is more likely due to peroxide formation in the diethyl ether. Therefore, dispose of any leftover solvent at the end of each day, and mix a fresh batch daily. It is recommended to store the leftover solvent in a properly labeled glass bottle and use as a rinse when cleaning the glassware.

Column Preparation

A piece of Chemfluor® tubing is needed as an extension of the Sep-Pak® cartridge so that it may be inserted well into the collection flask. This allows for the volatile elution solvent to drip without forming condensed water around the end.

1) Cut a 4.4 cm piece of the Chemfluor® tubing. Use a knife or needle file to bore out one end and force it on the Luer end of a used Sep-Pak® to pre-expand the stiff plastic. The fit should be snug and should fit up on the Luer end about ⅛″. This allows for easier placement on the unused Sep-Pak® prior to chromatography.

2) Cut the elution end (the end not bored out) of the Chemfluor® tubing to have a 45 degree angle end so that the solvent drips more uniformly. The Chemfluor® tubing pieces may be reused.

3) Open the sealed pack containing the Sep-Pak® cartridges immediately prior to use. Place the Chemfluor® tubing on the Luer end. Clamp the Sep-Pak® cartridge such that the Chemfluor® tubing is placed well into the flask (about ¼″).

4) Put a cork in the top of the Sep-Pak® to seal it until the sample is ready to be pipeted on top of the column.

5) After the sample aliquot has been added to the Sep-Pak® and rinsed with elution solvent, a 29/42 outerjoint, 24/40 inner joint glass adapter is force-fitted into the top of the Sep-Pak® to ensure a tight fit. This allows for the addition of the entire amount of elution solvent to start elution. No further column preparation is needed.

6) Experience has shown that it is best to run samples in triplicate. This helps to minimize any variances between the Sep-Pak® cartridges in parameters such as relative moisture, material density, particle size, amount of silica gel, pore size, and surface area.

Sample Preparation

1) Weigh 4.0±0.001 grams of the sample to an accuracy of 0.00001 grams into an equilibrated (step 3 of Preparation, above) 100 ml Class A volumetric flask. Tare the flask before weighing.

2) Take the weighed Erlenmeyer flasks and the volumetric flask(s) with the weighed sample(s) to the fume hood where the cartridges are.

3) Using a clean disposable Pasteur pipet, rinse the inner wall of the volumetric flask with petroleum ether (not the 87:13 elution solvent) to ensure that all of the sample is within the flask. Try not to touch the inner wall with the pipet until the inner wall has been rinsed. Swirl to mix, then fill about half-way with petroleum ether. Swirl again to presolubilize the oil. Dilute to mark and mix well by swirling and gently inverting back and forth.

If a sample is to be used for any length of time (such as a control sample), it should be flushed with nitrogen, capped tightly, and refrigerated. Experience has shown that even if a sample is stored in a light-proof container sealed under nitrogen gas, if left at room temperature, the sample will still slowly but steadily increase in the amount of polar materials. It is particularly important to store the control sample so that its % polar value will stay as consistent as possible over time.

To test for possible errors, the sample amount actually delivered can be checked for the pipet used. Pipet a 5 ml aliquot into a preweighed beaker, evaporate the solvent and determine the actual weight of the sample transferred. This should be done especially to ensure that new or duplicate pipets are identical in the amount of sample they are delivering.

Analysis of Sample

1) With a 5 ml Class A volumetric pipet, pipet 5 ml of sample solution onto the head of Sep-Pak® cartridge. If possible, use the same pipet for all analyses.

To avoid weighing errors, it is essential to use the same pipetting technique consistently. For pipets labeled TD, touch the pipet tip ONCE to the inner wall of the Sep-Pak® to remove residual sample and then remove the pipet. Experience has shown that deviating from the pipetting technique can affect the % polar values due to the small sample weights used in this analysis.

2) Rinse the sides of the Sep-Pak® with two, half-full, Pasteur pipetfuls of petroleum ether to ensure that all of the sample in the 5 ml aliquot is flushed into the Sep-Pak®.

3) Now, force-fit the 29/42 to 24/40 standard taper glass adapter onto the top of the Sep-Pak® cartridge. Make sure that the fit is tight and that the adapter is ˜⅛″ down into the cartridge.

4) Using a 50 ml graduated cylinder, measure 30 ml of elution solvent. Gently add the 30 ml of elution solvent to the top of the fitted glass adapter so as not to disturb the head of the column of the Sep-Pak.

5) Thoroughly rinse the volumetric pipet with petroleum ether between different samples and blow out with pipet bulb to dry.

6) When the last sample has had the elution solvent added, turn on the hot plate and set the heat control on the hot plate to about “2” (˜215° C.).

7) Allow the elution to continue until no more elution solvent elutes front the Sep-Pak® into the Erlenmeyer flask. This occurs shortly after the elution solvent completely drains into the silica of the Sep-Pak® (no solvent above head of column). Allow 5 more minutes past this point to allow complete elution.

Allow 30 minutes for a complete elution.

8) After the elution is complete, use one-half of a Pasteur pipetful to rinse the external walls of the Chemfluor® tubing on the Sep-Pak® with petroleum ether to make sure that all of the eluted non-polar fraction is in the flask. Start the rinse at the uppermost part of the tubing to ensure that any residual oil that may have migrated up the tubing is rinsed back into the flask.

Once the elution is complete and the Chemfluor® tubing is rinsed, the tubing may be taken off the used Sep-Pak® and re-used. Make sure that the inside of the tubing is rinsed with elution solvent before fitting it on a fresh Sep-Pak® cartridge.

Hydrogenated oils or oils containing significant levels of saturates, such as tropical fats (including palm, palm kernel, and coconut) may tend to form small amounts of crystalline whitish residue on the angled end of the outlet as the sample is eluting. It is important to make sure that this crystallized fat is rinsed into the collection flask to ensure an accurate weight of the eluted non-polar sample. In order to do so, use a heat gun on a low setting and gently heat the Chemfluor® tubing, thereby melting the crystallized fat. Once the tubing has been heated in this manner and the residue melted, hold the tubing with the angled end down, and rinse with petroleum ether into the collection flask using a pipet.

9) Rinse the inside of the neck of the Erlenmeyer flask with one-half Pasteur pipetful of petroleum ether to make sure that all of the non-polar fraction eluted is well inside the flask.

10) Attach a 1″ 3-prong clamp to a ring stand so that the clamp is suspended above the hot plate about 6″. Clamp a Pasteur pipet to the end of the nitrogen tubing so that the tip of the pipet is about 3″ above the middle of the hot plate; the tip should be centered about ½ inch above the flask mouth.

11) Gently place the Erlenmeyer flask containing the oil and elution solvent on the hot plate and adjust the flow of the nitrogen gas stream so that the surface of the solution is gently agitated. This eliminates the need to swirl the solution and minimizes the chance of the sample boiling. Boiling can cause the solution to splatter out causing loss of sample mass.

12) When the solvent visibly dries off, leave the sample on the hot plate and let the sample continue to dry under the nitrogen for another 5 minutes of extended drying. This ensures that any residual solvent is driven from the oil. It is important to observe the moment the solvent dries off in order to ensure that the flask does not receive more than 5 minutes of extended drying.

13) After the 5 minutes of extended drying, take the flask off the hot plate and cool under nitrogen for 12 minutes.

It is recommended that the nitrogen tubing be fitted with a manifold so a sample can be drying on the hot plate under nitrogen while a previously dried sample can be cooling under another stream of nitrogen. This allows one sample to be cooling while another sample is started in the drying sequence.

Experience has shown that the following are optimum drying times.

Evaporating solvent: ˜7 min

Continue heating to evaporate any residual solvent: ˜5 min

Cool under stream of nitrogen gas: ˜12 min

Total drying time: ˜24 minutes

A small timer with a beeper alarm is an excellent way to keep track of the approximate drying times.

14) After the flask has been cooled, place back in the dessicator near the balance to equilibrate for at least 30 minutes.

For convenience, it is recommended to start the 30 minute timer on this last equilibration step after the last cooled sample is put in the dessicator.

After the 30 minutes of equilibration time is elapsed for this last sample, all of the samples in the dessicator can be weighed at once, since they all have equilibrated at least 30 minutes.

15) Total time for complete analysis of one sample (elution through drying): ˜54 min

Determination of Polar Components

1) Weight of sample in 5 ml aliquot=[A] Weight of residue=[B]

$$\frac{[ A ] - [ B ]}{[ A ]} \times 100 \% = \% Polar$$

Disposal of Used Sep-Paks®

1) After use, place the used Sep-Paks® upright in a large beaker in the fume hood to allow residual solvent to evaporate prior to disposal. By reducing silica gel consumption and solvent usage by a factor of 5 compared to IUPAC method #2.507, the burden of lab waste disposal is reduced.

2) Allow the Sep-Paks® to sit overnight and dispose of in waste can the next morning. No special disposal procedures are necessary.

Storage of Sep-Paks®

1) Once a package of Sep-Paks® is opened, the package should have excess air squeezed out. Fold over the open end 2 or 3 times and seal with tape or staple. Store the sealed Sep-Pak® package in a desiccator.

Establishing a Control Range

1) Use a fresh oil and run 10 samples over 3 days. Average these 10 values and use the average as the actual control value. The daily control value should be within ±10% of the average. Run the daily control in duplicate and use the average to compare to the control value. If the average value of the duplicate set is not within this range, the entire run is in question and should be rerun. When three or more control samples are outside the ±10% limit, obtain a fresh reference sample and determine a new control value as described above. Always store the control sample sealed under nitrogen and in the refrigerator after use.

Store the control sample in 4 oz glass amber sample bottles with polyvinyl caps. Flush the headspace of the bottle with nitrogen and cap tightly before refrigerating. Remember to microwave and equilibrate before weighing.

It is recommended to split up the fresh oil into 4 oz bottles and use one bottle at a time. Meanwhile, the rest of the 4 oz bottles are kept refrigerated and sealed under nitrogen.

Accuracy of Analysis

1) For most samples, the expected maximum Standard Deviation of the analysis is ˜0.42 (±0.6).

Cleaning the Glassware

Rinse the Erlenmeyer flasks with petroleum ether, and empty into an appropriately labeled waste container. Let the flasks dry in the fume hood (or for quicker drying, dry with nitrogen), then wash with Alconox® or similar lab glassware detergent. Thoroughly rinse with deionized water, and place in drying oven.

Rinse the glass adapters and cartridge extensions with petroleum ether, dry, and store.

Empty the used dilutions into an appropriately labeled waste container. Rinse the volumetric flasks thoroughly with petroleum ether. Absolutely no oil residue should remain in the flasks. Rinse each polyethylene stopper, too. After rinsing, flush the flasks with nitrogen to dry, and cap.

References:

“Determination of Polar Compounds in Frying Fats,” International Union of Pure and Applied Chemistry, Standard Methods for the Analysis of Oils, Fats and Derivitives, 6th Edition, #2.507, Comission on Oils, Fats and Derivitives (1981)

“Waters Sep-Pak® Cartridges Care and Use Manual.” PNO11188 Revision 6 (August 1993)

Having now fully described the present invention in some detail by way of illustration and example, for purposes of clarity of understanding, it will be obvious to one of ordinary skill in the art that the same can be practiced by modifying or changing the invention with a wide and equivalent range of conditions, formulations and other parameters thereof, and that such modifications are intended to be encompassed within the scope of the appended claims.

All publications, patents and patent applications mentioned in this specification are indicative of the level of skill in the art to which this invention pertains, and are herein incorporated by reference to the same extent as if each individual publication, patent or patent application was specifically and individually indicated to be incorporated herein by reference.

What is claimed is:

1. A process for separation of the non-polar components of vegetable oil, the process comprising:
(a) preparing a vegetable oil sample for separation;
(b) introducing an aliquot of known mass of the vegetable oil sample into a pre-packed silica separation column of at least about 5 grams; and
(c) eluting the non-polar components of the aliquot with a solution comprising petroleum ether and diethyl ether having a petroleum ether:diethyl ether ratio from about 92:8 to about 82:18.

2. The process of claim 1, wherein said pre-packed silica separation column is a 5 gram column.

3. The process of claim 1, wherein said pre-packed silica separation column is a 10 gram column.

4. The process of claim 1, wherein said petroleum ether:diethyl ether ratio is from about 91:9 to about 83:17.

5. The process of claim 4, wherein said petroleum ether:diethyl ether ratio is from about 90:10 to about 84:16.

6. The process of claim 5, wherein said petroleum ether:diethyl ether ratio is from about 89:11 to about 85:15.

7. The process of claim 6, wherein said petroleum ether:diethyl ether ratio is from about 88:12 to about 86:14.

8. The process of claim 7, wherein said petroleum ether:diethyl ether ratio is about 87:13.

9. The process of claim 1, further comprising rinsing residual vegetable oil and/or crystallized fat residue after elution with petroleum ether, thereby separating residual non-polar components.

10. The process of claim 9, wherein said crystallized fat is melted prior to said rinsing.

11. A process for calculating the amount of polar components in a vegetable oil, the process comprising:
(a) preparing a vegetable oil sample for separation;
(b) introducing an aliquot of known mass of the vegetable oil sample into a pre-packed silica separation column of at least about 5 grams;
(c) eluting the non-polar components of the aliquot with a solution comprising petroleum ether and diethyl ether having a petroleum ether:diethyl ether ratio of from about 92:8 to about 82:18;
(d) drying the eluted non-polar components to remove the solvent, thereby obtaining a mass of dried non-polar components; and
(e) calculating the amount of polar components in the aliquot.

12. The process of claim 11, wherein said pre-packed silica separation column is a 5 gram column.

13. The process of claim 11, wherein said pre-packed silica separation column is a 10 gram column.

14. The process of claim 11, wherein said petroleum ether:diethyl ether ratio is from about 91:9 to about 83:17.

15. The process of claim 14, wherein said petroleum ether:diethyl ether ratio is from about 90:10 to about 84:16.

16. The process of claim 15, wherein said petroleum ether:diethyl ether ratio is from about 89:11 to about 85:15.

17. The process of claim 16, wherein said petroleum ether:diethyl ether ratio is from about 88:12 to about 86:14.

18. The process of claim 17, wherein said petroleum ether:diethyl ether ratio is about 87:13.

19. The process of claim 11, wherein step (c) further comprises rinsing residual vegetable oil and/or crystallized fat residue after elution with petroleum ether, thereby separating residual non-polar components.

20. The process of claim 19, wherein said crystallized fat is melted prior to said rinsing.

21. The process of claim 11, wherein at step (e) said calculating comprises subtracting the mass of the dried non-polar components from the mass of the aliquot of vegetable oil sample.

22. The process of claim 11 in which steps (c), (d), and (e) comprise the following:
(c) eluting the polar components of the aliquot with diethyl ether;
(d) drying the eluted polar components to remove the diethyl ether; and
(e) calculating the amount of non-polar components in the aliquot.
